(19) United States
(12) Patent Application Publication
(10) Pub. No.: US 2013/0169815 A1
(43) Pub. Date: Jul. 4, 2013

(54) EQUIPMENT ENCLOSURES WITH REMOTE LOGGING, AUTHORIZATION AND MONITORING

(71) Applicants: Mark Douglas Carney, Sterling, VA (US); Dante John Pacella, Charles Town, WV (US); Martin William McKee, Charles Town, WV (US)

(72) Inventors: Mark Douglas Carney, Sterling, VA (US); Dante John Pacella, Charles Town, WV (US); Martin William McKee, Charles Town, WV (US)

(21) Appl. No.: 13/340,307

(22) Filed: Dec. 29, 2011

(51) Int. Cl. H04N 7/18; G08B 29/00

(52) U.S. Cl. 348/156; 340/5.7; 348/E07.085

(57) ABSTRACT

A system and method for authenticating an operator may include a server configured to receive a request to access an enclosure, wherein the request may include at least one enclosure identification and at least one operator identification. At least one ticket associated with the enclosure identification may be identified. The server may determine whether the at least one ticket is associated with the at least one operator identification and transmit instructions to the enclosure in response to determining whether the at least one ticket is associate with the at least one operator identification.

### BACKGROUND

Junction boxes are enclosures that can house certain electrical components such as cross-connects and wiring used to supply services to a customer premises. Generally, these enclosures are locked using a standard lock and key. Once a key is issued to an operator, the operator may have access to any enclosure configured to receive that key. Further, multiple copies of a certain key may be distributed giving access to multiple enclosures by multiple operators. Under traditional methods, there is no way of knowing which operators have accessed certain enclosures or when the enclosures have been accessed. There is also no way of preventing an operator from replicating an issued key. There is a need for increased security with respect to the enclosures.

### BRIEF DESCRIPTION OF THE DRAWINGS

While the claims are not limited to the illustrated examples, an appreciation of various aspects is best gained through a discussion of various examples thereof. Referring now to the drawings, illustrative examples are shown in detail. Although the drawings represent the various examples, the drawings are not necessarily to scale and certain features may be exaggerated to better illustrate and explain an innovative aspect of an example. Further, the examples described herein are not intended to be exhaustive or otherwise limiting or restricting to the precise form and configuration shown in the drawings and disclosed in the following detailed description. Exemplary illustrations of the present invention are described in detail by referring to the drawings as follows.

FIG. 1 illustrates an exemplary authorization system;

FIG. 2A illustrates an exterior of an exemplary enclosure;

FIG. 2B illustrates an interior of the exemplary enclosure;

FIG. 3 illustrates an exemplary ticket system;

FIG. 4 illustrates an exemplary authorization process;

FIG. 5 illustrates another exemplary ticket system; and

FIG. 6 illustrates an exemplary process for responding to a security breach or service outage.

### DETAILED DESCRIPTION

An exemplary authorization system described herein includes associating an operator with an access device. The access device may be used to access an enclosure housing electrical components configured to deliver service to a customer premises. The operator may be authenticated by comparing the request to access a specific enclosure with problem tickets associated with that enclosure at a security server. The security server may also maintain a log of who has accessed each enclosure as well as when the enclosure was accessed. Thus, an interactive authentication system provides increased security and accountability with respect to each of the enclosures.

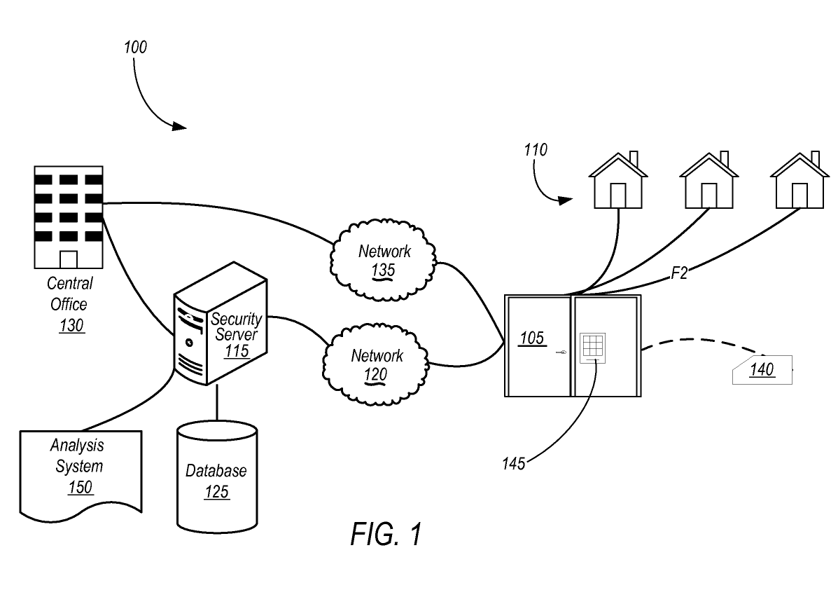

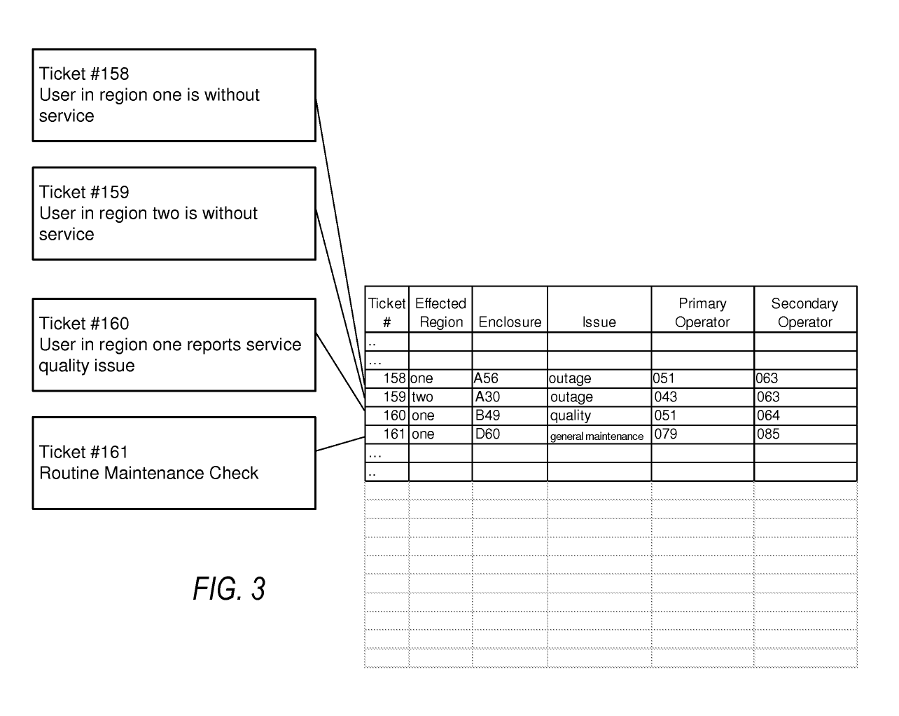

As illustrated in FIG. 1, an illustrative system 100 generally includes one or more enclosures 105 associated with at least one customer premises 110. The enclosure 105 may be in communication with a security server 115 via a network 120. The security server 115 may include a database 125 configured to maintain a plurality of tickets (shown in FIG. 3) propagated by a central office 130. The central office 130 and the security server 115 may be in communication with each other via another network. The security server 115 may communicate to the enclosure 105 whether to grant or deny access to the enclosure 105 based on an identification associated with an access device 140 used to request such access via an access panel 145 located on the enclosure 105. The security server 115 may also include an analysis system 145 configured to analyze data received from the enclosures 105. The security center 115 may be located at or beyond the central office 130.

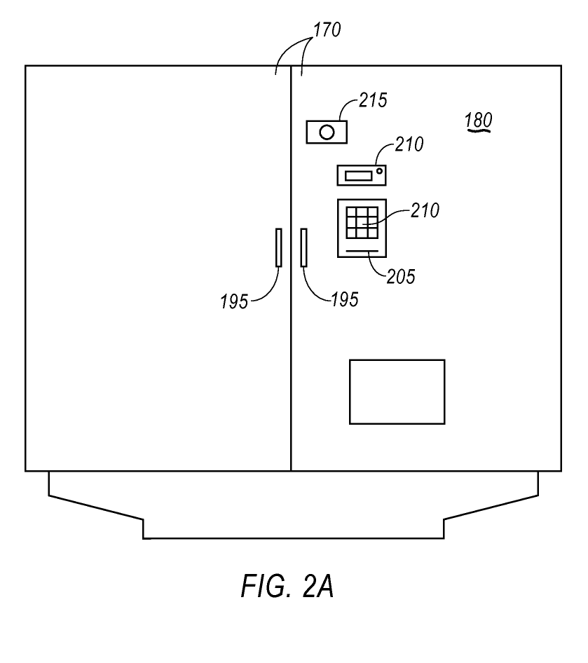

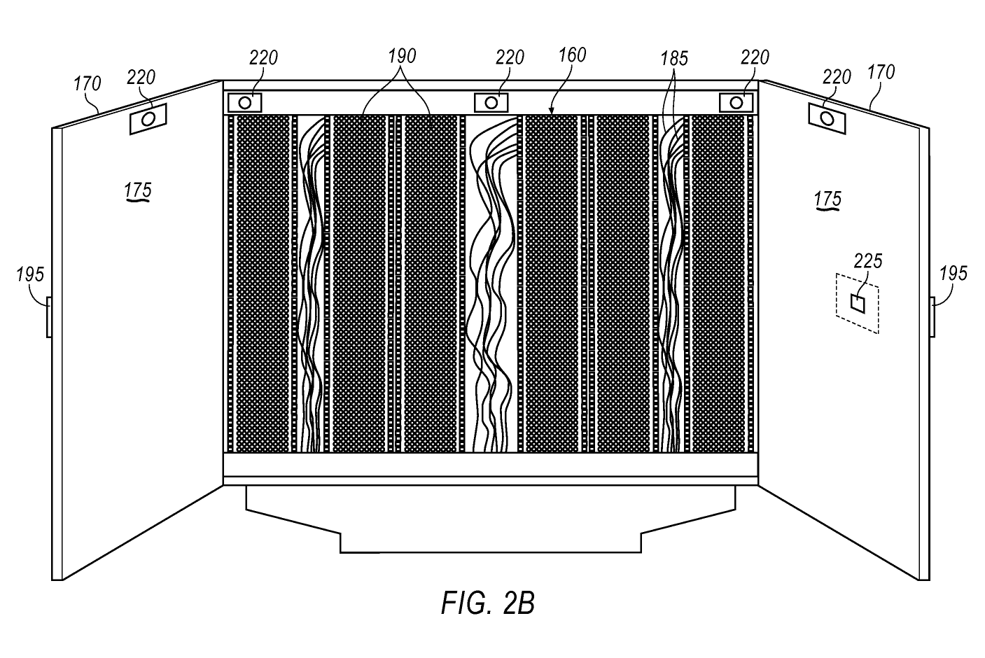

The enclosures 105, as detailed in FIGS. 2A and 2B, may be a telecommunication cabinet having at least one door 170 (or access panel) for housing utility components 160 in the inside of the enclosure. The utility components 160 may be electrical components such as serving area interfaces (SAIs), cross-connect systems, binding posts, etc. The enclosures 105 may also contain Optical Network Terminal (ONT) devices, or other devices associated with standard utility services such as gas, electric, cable and water. At least one door 170 is disclosed and in the exemplary illustration two doors 170 are shown. Each door 170 may have an inner side 175 and an outer side 180. Each door 170 may also include a handle 195 on its outer side 180. In alternate implementations, the door 170 may not have a handle and may rely upon remotely or locally triggered magnetic or physical locking devices to open. The enclosure 105 may be at ground level or mounted to a structure such as a telephone pole. Additionally, the enclosure may be included within a residential Multi-Dwelling Unit (MDU) or an office site. In other implementation, the enclosure may be any enclosed space with a removable or operable door, panel, cover or hatch protecting utility-specific equipment and/or assets. Certain cross-connect systems housed by the enclosures 105 may provide service to a plurality of subscribers within the vicinity of the enclosure 105 and thus should be protected from damage in an effort to minimize service outages.

Generally, and as shown in FIG. 2B, in one exemplary approach when enclosure 105 is used with land-line based telephone wires, individual pairs of a telephone local loop 185 terminate at the enclosure 105. The enclosure 105 may house at least two binding posts 190. One binding post may be a distribution post and another may be a feeder post. Cables may connect the two posts 190 together to deliver service to the subscribers at the customer premises 110. As shown in FIG. 1, service is delivered via a secondary feeder cables F2 extending from the enclosure 105. A main feeder cable F1 (not shown) may connect the enclosure 105 to the security server 115 and/or the central office 130. Thus, service may be delivered from the central office 130 to the customer premises by the feeder cables F1, F2 and the cable connections within the enclosure 105. In some implementations, the connection between the enclosure 105 and security server 115 may exist as a separate wireless or wired connection. Alternatively, enclosures 105 may communicate status to one another to be relayed back to the security server 115 and not have direct connections to the security server 115 themselves. In some implementations, the delivery method to the next enclosure 105 or customer premises 110 may be optional cable, wireless signal, coaxial cable or other forms of communication as should be obvious to one practiced in the art.

Returning back to FIGS. 2A and 2B, the enclosure 105 may include a locking mechanism (not shown) disposed within the at least one door 170. The locking mechanism may be controlled by an access panel 145. The locking mechanism may include any type of device capable of locking the doors 170 of the enclosure 105 and providing security for the enclosure 105. For example, the locking mechanism may include a dead bolt lock that may be triggered in response to a command from the access panel 145. It may include a releasable latch, pin, or wafer. The locking mechanism may include a pair of releasable magnets configured to hold the doors 170 a secure position.

The access panel 145 may be disposed on the outer side 180 of an enclosure door 170 and be used by an operator to request access to the enclosure 105. The access panel 145 may be operated in combination with an access device 140, as shown by way of example in FIG. 1. The access device 140 may be any type of device having a unique identification associated with the specific device 140 so that each operator associated with the device 140 may be identified based on the unique identification. For example, each operator may be assigned an access device 140 and each access device 140 may include an identifying number. The association between the operator and the identifying number may be maintained in database 125 within the security server 115. Additionally or alternatively, the association may be maintained by the central office 130, or some other remote terminal including a third party security company.

The access devices 140 may be activated, deactivated and reactivated by each of these entities. For example, the security server 115 may issue a new access device 140 to a new operator. The security server 115 may also replace damaged devices. The security server 115 may also deactivate an access device 140 at any time without the need for the operator to return the device 140. For example, the identification associated with the access device 140 may be identified as inactive. This may be necessary in the instance where an operator is no longer employed by the service provider. The access device 140 may also be temporarily or permanently disabled in the event of a disturbance, change in circumstances, or even in the event that disciplinary action is necessary against a specific operator. Thus, the access device 140 may be dynamically updated in real-time or substantially real-time in view of the current circumstances of an individual operator or group of operators (e.g., the access device only works during a specific shift). If and when the circumstance resulting in disabling the access device 140 change, the group of operators may then be restored to active status, allowing the operators to continue accessing a specific enclosure or group of enclosures 105. Any change in status among the access devices 140 may be performed at the security center 115 without the operator needing to physically present the device 140.

The access device 140 may also include capabilities such as wireless communication abilities and tracking abilities. A tracking device may be included in the access device 140 and may include a global positioning system (GPS) receiver configured to identify the location of the access device 140. The access device 140 may have wireless communication abilities so that the location of the device may be communicated to the security server 115, central office 130, or another remote location. By identifying the location of the access device 140, the location of the operator associated with the access device 140 may also be established. The security server 115 may maintain a log of the operators and their respective locations. As described below with respect to FIG. 3, the location of the operators may be used to associate a problem ticket with a specific operator.

The access device 140 may be any device capable of containing data readable by the access panel 145. For example, the access device 140 may be any device that includes a radio-frequency identification (RFID) tag. An RFID tag may wirelessly transfer data the object it is adhered to, to an RFID reader (e.g., the access panel 145) in order to identify the object. An RFID tag may be fixed to any object. For example, an RFID tag may be affixed to an access card distributed to each operator. The tag may also be affixed to an employee identification badge, a key ring, mobile device, etc.

The access device 140 may also include a near field communication (NFC) chip. Such chip may transmit data wirelessly over a short distance. The access panel 145 may then be configured to read the data transmitted by the NFC chip. Such data may include the unique identification associated with the operator. The NFC chip may be embedded into a mobile device such as a mobile phone, tablet computer, Smartphone, etc. By waiving the mobile device within close proximity of the access panel 145, the access panel 145 may then use the data within the NFC chip to verify the identity of the operator. The access device 140 may also be a mobile device configured to transmit data via Bluetooth technology. Similar to NFC technology, Bluetooth technology may transmit data embedded in an electronic device or chip wirelessly to a receiver in close proximity.

The access device 140 may also include a 1-Wire component. 1-Wire is a communication system that may also transmit data to a receiver. The 1-Wire component may include the unique identification associated with the operator. Further, the 1-Wire may be integrated as part of a circuit board, or it may be a stand-alone device, such as an iButton. The iButton may be a small disk-like button configured to physically connect with a socket. The access panel 145 may include such a socket and be configured to receive the unique identification from the iButton, using it to verify the identity of the operator.

In addition to the above mechanisms, access panel 145 may also include a key pad 200 having a plurality of selectable digits. The key pad 200 may be capable of receiving inputs from an operator. The input may be a secret combination of pre-defined digits. The secret combination, when entered via the key pad, may unlock the locking mechanism. The access panel 145 may also define a key slot 205 for receiving a key capable of manually unlocking the locking mechanism, such as the access device 140. In some instances, the access panel 145 may accept the access device 140, and upon verifying the identity of the operator based on the unique identification within the access device 140, may subsequently also ask for a secret combination to then be inputted into the key pad 200. Thus, a two-tiered identification approach may be implemented. The access panel 145 may also use other forms of identification such as fingerprint analysis, voice recognition, face recognition, etc. The access device 140 may include a biometric reader capable of receiving a fingerprint identification and therefor authenticating an operator at the access device 140. Additionally or alternatively, the key pad 200 may accept a unique user number and either a static or time-based passcode and these may be verified by a security server 115.

The access panel 145 may include a status indicator 210 such as a light or display so that the operator may be alerted as to the status of the request to access the enclosure 105. For example, if access to the enclosure 105 is pending, the light may be yellow. Additionally, if access to the enclosure 105 is denied, the light may turn red, or if access is granted, the light may turn green. Similar indicators may be shown via textual representations on a display such as a liquid crystal display, light emitting diode display, etc. Additionally or alternatively, the status indicator 210 may include a speaker (not shown) configured to play a sound indicating the status of the request. For example, the speaker may play a certain sound, such as a chime, upon the request being granted. The speaker may also play a phrase, such as “Access Denied,” or “Access Granted,” based on the response to the request.

Both the inside and outside of the enclosures 105 may include devices capable of recording the circumstances surrounding the enclosure at any given time. For example, cameras and microphones may be disposed both on the inside and outside of the enclosure 105. The recordings taken by these devices may increase security of the enclosure 105. In one example, the outer side 180 of the doors 170 may include an outer camera 215 for recording activity exterior to the enclosure 105. For example, the outer camera 215 may record the operator as he or she approaches the access panel 145. The outer camera 215 may also record any unauthorized person attempting to access the enclosure 105, such as vandals. The camera 215 may include a motion sensor. In this case, the outer camera 215 may record only after motion has been detected. This eliminates cumbersome and lengthy recordings. Additionally or alternatively, the camera 215 may be triggered by the security center 150. The security center may instruct the camera 215 to begin recording in response to any number of predetermined events. For example, the camera 215 may be triggered to record based on a set time schedule. The camera may only be scheduled to record during high crime times, such as early morning or late night. Moreover, the camera may be triggered to record in response to an unauthorized access of a related enclosure. The enclosure 105 may also contain other sensors (not shown) such as physical, magnetic, motion or electrical tamper switches to detect changes in the equipment and/or environment in order to trigger recording devices such as outer camera 215.

The outer camera 215 may be capable of recording in low or no light. The outer camera 215 may include infra-red technology to enable night time viewing and recording. The outer camera 215 may be able to take both video and still photos. These recordings may be sent via the network 120 or main feeder cable F1 to the security server 115 for analysis by the analysis system 150. The recordings may also be sent via a wireless backup system. The outer camera 215 may be integrated into the access panel 145, or it may also be a separate component mounted to the outer side 180 of one of the doors 170.

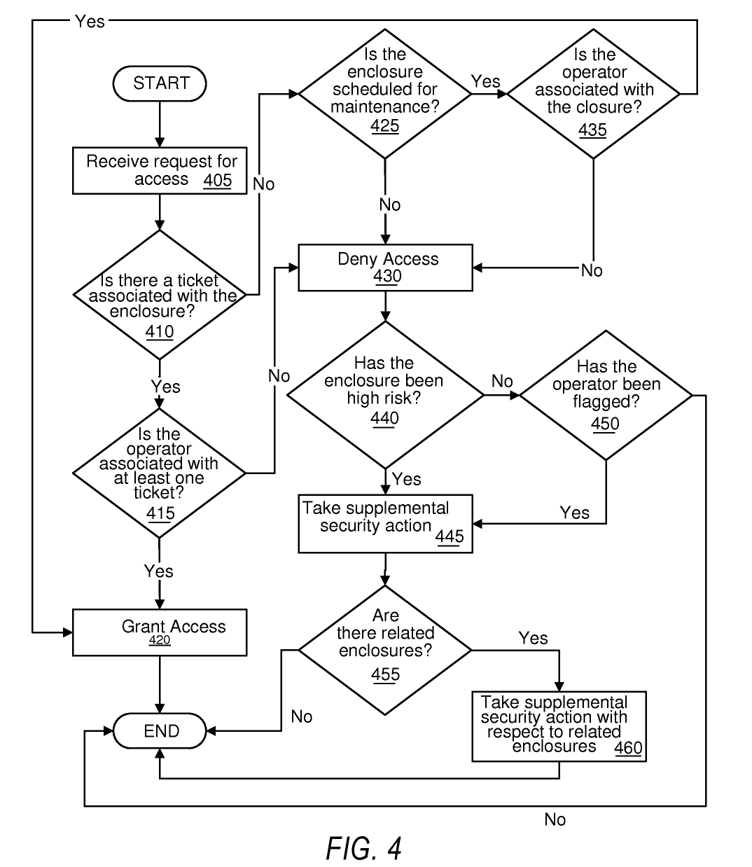

The enclosure 105 may also include a wireless network interface 225, shown in FIG. 2B, to communication with the security server 115 via the network 120. The wireless network interface 225 may connect to a computer network, such as networks 120, 135 in FIG. 1. The network interface 225 may include a wireless network card, Peripheral Component Interconnect (PCI) mini card, Universal Serial Bus (USB) 2.0, etc. It may enable the enclosure 105 to wirelessly communicate with other terminals such as the security server 115 or central office 130. For example, the security server 115 may receive a request to access the enclosure 105 via the access panel 145. The security server 115 may verify that the access device 140 requesting the access is a permitted access device 140 and therefore instruct the access panel 145 to open the locking mechanism at on the enclosure doors 170. This is described in more detail with respect to FIG. 4.

Moreover, the wireless network interface 225 may be secured to the enclosure 105 so that it may not be removable, at least without difficulty. The wireless interface 225 may be hidden, or unreachable in the enclosure 105. This may allow the interface 225 to maintain communication with another terminal (e.g., the security server 115 or central office 130) even in the event of damage or vandalism to the enclosure 105. Moreover, by fixing the wireless interface 225 securely to the enclosure, the interface 225 may not be easily disabled, thus increasing security of the enclosure 105. In one example, the wireless interface 225 may be in communication with the back side of the access panel 145, shown in phantom in FIG. 2B. In another example, the wireless interface 225 may be disposed behind the utility components 160, thus being out of sight and out of reach.

Similar to the outer camera 215, the inside of the enclosure 105 may also include at least one inner camera 220. The inner camera 220 may record the circumstances of the inside of the enclosure, both as the door 170 is open as well as closed. There may be plurality of inner cameras 220. For example, there may be at least one inner camera 220 disposed on the inner side 175 of the enclosure doors 170. There may also be at least one camera 220 disposed within the enclosure 105. The photos and/or video recorded by the inner cameras 220 may record the atmosphere inside the enclosure 105 at different points in time. For example, the recordings may be scheduled at specific time intervals, or at specific times of day. Similar to the outer camera 215, the inner camera 220 may also be triggered by a motion sensor, thus avoiding long streams of irrelevant recordings.

At least one inner camera 220 may be positioned towards the inner side 175 of the enclosure doors 170. Thus, when the doors 170 are opened, the inner camera 220 may record the operator. This recording may be used to confirm that the appropriate operator is accessing the enclosure 105. Moreover, the recording may be used to identify unauthorized persons attempting to access the enclosure 105. At least one other inner camera 220 may be faced towards electronic components 160 and configured to capture images of the cross-connect, binding posts 190, cables, etc. In one example, an inner camera 220 may be located on the inner side 175 of the enclosure door 170. The recordings taken of the components 160 may then be used to compare certain recordings taken at different times. For example, a recording taken before an operator services a cross-connect may be compared with another recording taken after the enclosure 105 has been serviced. Specifically, recordings taken of the cable configurations between the binding posts 190 before the operator serviced a cross-connect may be compared with recordings of the cable configurations after the service. The recordings may also be used to determine the cause of a problem. For example, debris may be caught within the cross-connect causing it to malfunction. A review of the recordings taken of the enclosure 105 may show this, and thus alert the security server 115 as to the cause of the malfunction. Moreover, animals may become trapped within the enclosure 105. Yet another common problem that could be observed via the recordings is the existence of an insect nest such as a hornets nest or bee hive.

At least a portion of the inner and outer cameras 215, 220 may be either one of a hidden or false camera. By placing false cameras throughout the enclosure, unauthorized persons may not know which of the cameras to cover in an effort to conceal their identity. Hidden cameras may capture at least a portion of the surrounding circumstances even if one of the unhidden cameras is damaged or covered during an unauthorized access.

Microphones may also be installed within the enclosure 105 to record sound bites. Microphones may be triggered to record via the motion sensor. Additionally or alternatively, the microphones within the enclosure 105 may also be configured to record upon access being granted to the enclosure 105, or upon the enclosure doors 170 opening. The microphones may record sound bites to help identify unauthorized person attempting to access the cross-connect. Moreover, the sound bites may be used for training purposes. Speakers may also be included in the enclosure 105. Speakers may be included in the exterior or interior of the enclosure 105. The speakers may alarm and warn unauthorized persons as they approach the enclosure 105. The speakers may also sound an alarm when the enclosure's security is breached. Moreover, the speakers may provide guidance to the operator. For example, the speakers may allow the security server 115 to provide step by step instructions to the operator on how to fix or address a problem. The speakers and microphones may also enable operators at two different enclosures 105 to communicate while both service their respective enclosure 105. The speakers and microphones may be integrated into at least one of the access panel 145, inner and outer cameras 215, 220, or utility components 160.

The access panel 145 may include, or be attached to, an internal battery located within the enclosure 105. The internal battery may be disposed on the inner side 175 of the enclosure doors 170, or on at least one of the enclosure walls so that it is not externally accessible. The outside of the enclosure 105 may include an electrical producing mechanism (e.g., for recharging a battery) such as a solar panel configured to convert solar energy into power for the devices within the enclosure 105 (e.g., the access panel 145, wireless interface 225, and cameras 215, 220.) Moreover, the devices within the enclosure 105 may be in communication with embedded storage (e.g., flash memory). Thus, certain recordings taken by the cameras 215, 220 may be stored in the embedded storage. The embedded storage may also store a local log of the access attempts to the enclosure 105. Any data stored within the embedded storage may be uploaded to the security server 115 on a periodic basis. The embedded storage may also receive periodic updates from the security server 115 indicating which, if any, of the operators should be permitted access to the enclosure 105.

Returning to FIG. 1, the secondary feeder cables F2 may connect the cross-connect with customer premises 110. The customer premises 110 may be a dwelling unit, building, business, campus, or any physical location capable of receiving service from a central office 130. The main feeder cable F1 may connect the cross-connect to a remote terminal, central office 130 or, as shown in FIG. 1, a security server 115.

The security server 115 may be in communication with the enclosure 105 via network 120 such as the internet or 3G/4G data network using the wireless interface 225. For example, data networks such as, High-Speed Downlink Packet Access (HSDPA), Universal Mobile Telecommunications System (UMTS), High-Speed Packet Access (HSPA), WiMax and Long Term Evolution (LTE) may be used to facilitate communication between the security server 115 and the enclosure 105.

The security server 115 may be a terminal capable of maintaining the security of the enclosures 105 including the components stored therein. The security server 115 may also be capable of receiving information from the enclosure 105 via the network 120 and/or main feeder cable F1.

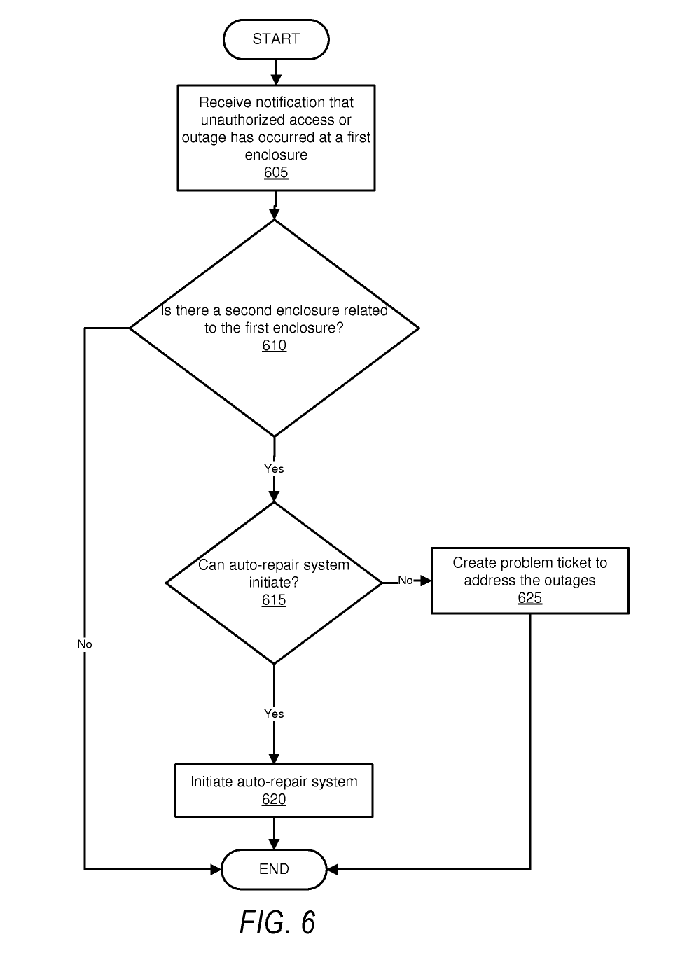

The security server 115 may be in communication with a database 125. The database 125 may include information and data related to the enclosures 105. For example, each enclosure 105 may be associated with a region. Each enclosure 105 may also be managed by at least one operator, such as a technician or manager. Each operator may be associated with a specific access device 140. The database 125 may maintain this information and catalog it by operator, enclosure, and/or region. The security server 115 may also receive ticket information associated with a problem ticket generated at the central office 130. The database 125 and ticket information are described in more detail below with respect to FIG. 3. The database 125 may also include a circuit database that may indicate which enclosures 105 are in communication with each other, as well as their location, and customer premises 110 that they service. The circuit database may facilitate re-routing of certain services based on the enclosures' relationship with each other, as described in more detail with respect to FIG. 6.

The security server 115 may also include an analysis system 150 configured to analyze data received from the enclosure 105. The analysis system 150 may analyze the operators and the enclosures 105 for efficiency, reliability, etc. For example, the analysis system may be configured to compare two still photos of the enclosure 105 at different points in time (e.g., before and after operator access) to evaluate the operator's service of the enclosure 105. Moreover, the analysis system 150 may generate a list of the most serviced enclosures 105, the enclosures 105 having the highest amount of down-time, and the like.

The central office 130 may be in communication with the security server 115 via network 135 such as the internet or 3G/4G data network. Similar to network 120, data networks such as, HSDPA, UMTS, HSPA, and LTE may be used to facilitate communication between the security server 115 and the central office 130. Additionally or alternatively, the central office 130 may be in communication with the security server 115 and/or the enclosure 105 via the main feeder cable F1.

Further, although the example in FIG. 1 shows networks 120, 135 as being separate networks, networks 120, 135 may also be the same network in some implementations. For example, networks 120, 135 may be a wireless data network configured to permit communication between any one of the central office 130, security server 115 and enclosure 105.

The central office 130 may transmit signals to a customer premise 110 via cables (e.g., F1) and the cross-connect or other switches. The central office 130 regulates and maintains the subscriber subscriptions associated with each customer premises 110. The central office 130 also may receive calls, emails, etc., from subscribers indicating problems with their service, such as outages, quality issues, and the like. In response to receiving a complaint about a server, the central office 130 may create a ticket including ticket information. The ticket information may include fields such as those described with respect to FIG. 3, including, for example, the type of problem (e.g., service outage) and the enclosure 105 associated with the customer premises 110. The central office 130 may then associate an operator with that problem ticket. The association may be based on several aspects, including but not limited to, the type of problem reported, the enclosure, the region of the enclosure, the time of day the complaint was received and/or the time of day the enclosure 105 may be serviced, etc. Moreover, a secondary operator may also be assigned to the ticket. This is described in detail below.

FIG. 3 shows an exemplary ticket system 300 as referenced above. The ticket system 300 may collect, collate and save tickets received from the central office 130. For example, when a user experiences problems with his or her service, a ticket may be created at the central office 130. The user may call a call center (not shown) to report a problem. The user may also send an electronic message (e.g., an email, Short Message Service (SMS) message). Additionally or alternatively, the problem may be detected automatically by the service provider and a ticket may be automatically generated. For example, a routine test may indicate that a certain region has lost access to premium channels provided by the service provider. Thus, a ticket may be created without user action being required. Once a ticket has been generated at the central office 130, the ticket may be sent to the security server 115.

When the ticket is received at the security server 115, the ticket may be saved and cataloged in the database 125. Alternatively, before being saved in the database 125, the ticket may be assigned, or associated with, a specific operator. This association may be determined by a look-up table saved in the database 125. The look-up table (not shown) may be a pre-generated table providing a list of the operators. Each operator may be associated with specific attributes, such as a specific enclosure, region, type of problem, etc. Certain operators may be associated with more than one attribute. For example, a first operator may be associated with more than one enclosure 105. A second operator may be associated with an entire region. A third operator may be associated with a type of problem and two regions. Moreover, certain operators may be termed managers, and thus be associated with all of the attributes of the operators that he or she oversees. For example, a fourth operator may oversee the second and third operators and thus may be associated collectively with the regions associated with the second and third operators, as well as the type of problem associated with the third operator.

Additionally or alternatively, the operators may be assigned to a specific ticket based on their current location. As explained previously, the security server 115 may maintain a list of the operators and their current physical location determined by GPS technology. Based on the current location, an operator may be assigned to a ticket based on his or her vicinity to the enclosure 105 associated with the ticket. The locations of the operators may also be used to coordinate actions needed in servicing multiple enclosures. For example, if the cross-connects of two enclosures 105 are related, both may need to be serviced in order to fully restore service to the customer premises 110. If a first operator is servicing a first enclosure, he or she may contact an operator in the vicinity of a related second enclosure 105 to help coordinate efforts. Moreover, if an operator needs assistance servicing an enclosure 105, the security server 115 may dispatch the next closest operator to the enclosure 105.

In another example, referring to FIG. 3, ticket #158 may indicate that a user is without service in region one. The security server 115 may then use the lookup table to determine which operators are associated with both region one and service outages. The operators may be identified by name, number, etc. In the exemplary table in FIG. 3, the operators are identified by number. Referring to ticket #158, the security server 115 may catalog the ticket once an operator has been assigned to that ticket. In this example, a primary operator and secondary operator have each been assigned to the ticket. The secondary operator may be the manager responsible for overseeing the primary operator. Additionally or alternatively, the secondary operator may be an operator responsible for a nearby region and would be responsible for the ticket in the event that the primary operator was unavailable.

In yet another example, the primary and secondary operators may be associated with the same region, as well as the same type of problem, and the assignment by the security server 115 may be made on a purely random basis. Additionally or alternatively, the security server 115 may decide which two equally qualified operators to assign to a ticket based on the work load of the two operators. The lookup table may also include a queue of operators and the operators may be assigned purely based on their location in the queue. Once an operator is assigned to a ticket, that operator is moved to the bottom of the queue. Thus, several methods of determining which operator to assign to a specific ticket can be used. Additionally or alternatively, the central office 130 may assign an operator to each ticket using the methods described herein, or other methods.

As is discussed below with respect to FIG. 4, the table in FIG. 3 may be used to lookup whether or not a request to access an enclosure 105 is a permitted request. The table is an exemplary showing of how ticket information may be cataloged. Other methods may be used to catalog the tickets.

FIG. 4 shows an exemplary process 400 for authenticating a request to access an enclosure 105.

At block 405, the security server 115 may receive a request to access an enclosure 105. This request may be initiated by a person wishing to gain access to the utility components 160 housed by the enclosure 105. For example, the person may be an operator responding to a service request. The person may also be a manager performing routine maintenance. Moreover, the person may be someone that is not associated with the central office 130 or the service provider at all, but simply a curious bystander. In a more sever situation, the person may be a vandal attempting to access the enclosure 105 for malicious reasons. The request to access the enclosure 105 may be initiated by any of the methods described above. For example, an operator may swipe his or her access device 140 across the access panel 145. The Access panel 145 may read the identification information round in the access device 140, and transmit this information to the security server 115. The identity of the enclosure 105 is also transmitted. The information may be sent over the main feeder cable F1, as well as network 120 via the wireless interface 225. In the case where the information is transmitted over the feeder cable F1, the identity of the enclosure 105 may be determined by the wire itself. The process proceeds to block 410.

At block 410, the security server 115 determines whether a ticket associated with the enclosure 105 has been generated and saved in the database 125. For example, the security server 115 may run a query through the database 125 (e.g., the table) and determine if there is a pending ticket or tickets for the identified enclosure 105. If there is at least one ticket, then the process proceeds to block 415. If no ticket is found, the process proceeds to block 425.

At block 415, the security server 115 determines whether the operator requesting the access via the access device 140 is associated with one of the tickets associated with the enclosure 105. If there are numerous tickets associated with the identified enclosure, only one of the tickets needs to identify the operator. The operator may be identified by an operator identification stored within the access device 140. The operator may be either of the primary operator or the secondary operator. More than two operators may be associated with a ticket, and the table is merely an exemplary configuration. If the operator is associated with a ticket, then the process proceeds to block 420. If the person attempting access is not an operator associated with a ticket, the process proceeds to block 430.

At block 420, the security server 115 may transmit instructions to the access panel 145 indicating that the request should be granted. Upon receiving the signal, the access panel 145 may unlock the locking mechanism, thus giving the operator access to the enclosure 105. Upon receiving the signal, the access panel 145 may indicate to the person attempting access that the access has been granted. This may be done via the status indicator 210 as described above.

At block 425, in response to the security server 115 not having a ticket associated with the identified enclosure, the security server 115 may determine if the enclosure 105 is scheduled for routine maintenance. Although a ticket may be generated for routine maintenance, this may not always be the case and the security server 115 may maintain a schedule, separate from problem tickets, for all routine maintenance. Thus, the process may confirm that maintenance is scheduled for the identified enclosure 105. If such maintenance is scheduled, the process proceeds to block 435, if not, the process proceeds to block 430.

At block 435, the security server 115 may determine if the person attempting to access the enclosure 105 is an operator associated with the enclosure 105. This may be determined by using the lookup table discussed above. It may also be determined based on the maintenance schedule maintained in the security server 115. If the operator is associated with the enclosure, the process proceeds to block 420, if not, the process proceeds to block 430.

At block 430, the security server 115 may transmit a signal to the access panel 145 indicating that the request should be denied. Upon receiving the signal, the access panel 145 may indicate to the person attempting access that the access has been denied. This may be done via the status indicator 210, as described above. In another example, in the event that the access panel 145 does not receive a signal from the security server 115, the status indicator 210 may indicate such. In this situation, the doors 170 may remain locked so as to preserve the security of the enclosure 105. Additionally, if access has been denied, the access device 140 may include an override failsafe key, allowing the operator to access the enclosure regardless of the response from the security server 115. The operator may also override denied access by entering a pre-shared override code at the access panel 145. In block 430, when the access request is denied, the process proceeds to block 440.

At block 440, the security server 115 determines whether the enclosure 105 has been flagged as high risk. This may be done by indicating such within the lookup table. Additionally or alternatively, the security server 115 may maintain a list of flagged enclosures, or a list of flagged regions including such enclosures. Enclosures 105 may be flagged if one has been damaged or vandalized before. Enclosures 105 may also be flagged if they are located in a high risk zone, where other enclosures 105 have been damaged, or where the crime rate is higher than usual. Enclosures 105 may also be flagged if too many unauthorized access attempts have been attempted. If the enclosure 105 has been flagged, the process proceeds to block 445, if not, the process proceeds to block 450.

At block 450, the security server 115 determines if the person attempting access is a flagged operator. Similar to an enclosure 105 being flagged, an operator may also be flagged. For example, an operator may be a terminated employee that is attempting to access the enclosure 105. The operator may also be an employee that is on a temporary leave or not scheduled to be working at the indicated time, etc. and thus may be flagged. The security server 115 may maintain a list of the flagged operators. If the operator is a flagged operator, the process proceeds to block 445, if not, the process ends.

At block 445, the security server 115 may send instructions to the access panel 145 indicating that a supplemental security action should occur. This supplemental security action is taken to further protect the enclosure 105 from possible damage upon a determining that either the enclosure 105 is in a high risk area, or that the person attempting access has been flagged. The supplemental security action may include any one or combination of actions such as throwing a deadbolt, sounding an alarm, notifying law enforcement of the potential threat, etc. In addition to any of these actions, the camera on the outer side 180 of the enclosure doors 170 may take a photo or video of the person requesting access. The photo and/or video may then be sent to the security server 115 for further analysis. The process then proceeds to block 455.

At block 455, the security server 115 determines whether or not there are any related enclosures 105 to that which access was attempted. For example, a related enclosure 105 may be one that is in the same region as the initial enclosure 105. If there are related enclosures, the process proceeds to block 460, if not, the process ends.

At block 460, the security server 115 may send instructions to each of the related enclosures 105 indicating to the access panel 145 that a supplemental security action should be taken with respect to each of the related enclosures 105 (e.g., throwing the deadbolts for each of the related enclosures.) This may prevent other enclosures 105 from being damaged. Accordingly, if an operator with a legitimate reason (e.g., problem ticket) requires access a related enclosure, the supplemental security action may be removed upon access being granted (e.g., the deadbolt withdrawn.) The process then ends.

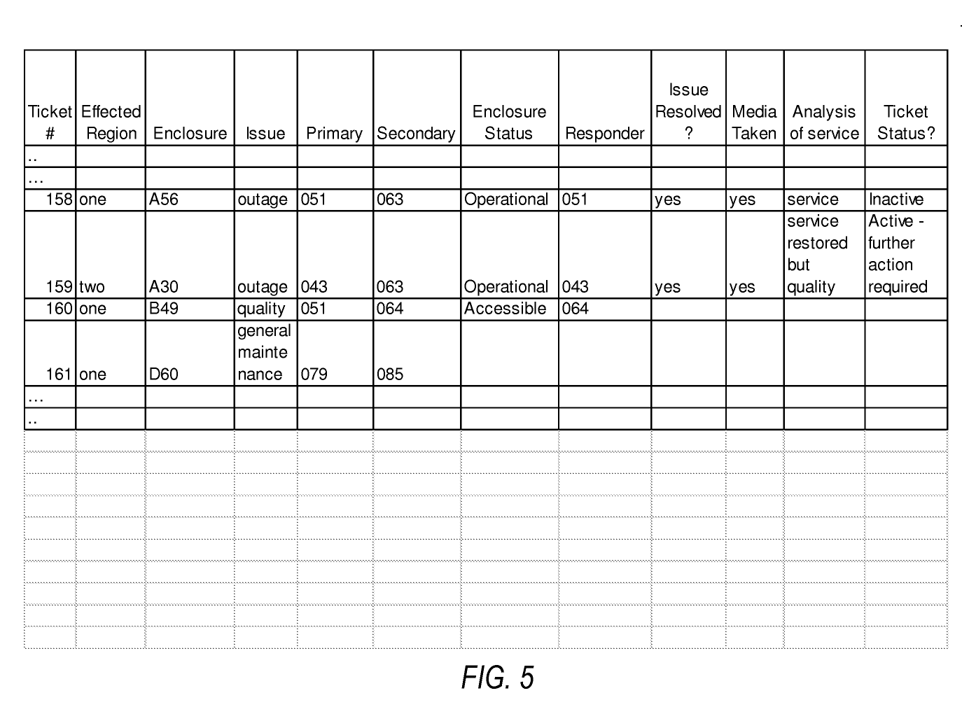

FIG. 5 shows an exemplary updated table stored in the database 125 at the security server 115. The table may be updated at the security server 115 as the tickets are addressed by the operators. For example, once an issue has been resolved, the ticket relating to that issue may be closed. Once the ticket is closed, it may no longer be used to verify the credentials of an operator for the purposes of granting access to the enclosure. The ticket may be removed from the table, or may be indicated as ‘inactive’.

The table may identify if and which operator has responded to the ticket. The table may also indicate the status of the enclosure 105. An enclosure 105 may be “operational” if it has already been accessed by an operator. Alternatively, it may be “accessible” if it is currently being accessed (e.g., the doors 170 are unlocked and open). An enclosure 105 may also be damaged, and therefore it may be neither operational nor accessible. As an example, referring to ticket #158 in FIG. 5, the enclosure 105 may be considered “operational,” while the ticket #160 may be considered “accessible.” The table may also indicate if the issue was resolved. For example, if service was restored to region one then the issue may be considered resolved. Alternatively, if service was not restored and additional attention may be required then the issue may be considered unresolved.

The table may also indicate if any recordings were taken either before, during and/or after the operator's access to the enclosure 105. For example, the interior cameras 220 may record still shots and video of the utility components 160 before the operator proceeds to address the issue established by the ticket. The interior cameras 220 may also record photos and/or video during and after the operator's presence at the enclosure 105. The recordings taken before the operator's access may be compared to the recordings taken after the operator has finished servicing the enclosure 105. The recordings may be used by the security server 115 to critique and analyze the operator's performance. For example, the recordings may show which and how each cable is connected at the binding posts 190 at the time the problem is reported. The operator may then respond to the ticket by modifying the current wiring between the binding posts 190 within the enclosure 105 to correct the problem. The security server 115 may compare the two configurations to determine whether the operator's actions were appropriate under the circumstances. A manager may be responsible for the analyzing the recordings at the security server 115. Additionally or alternatively, the recordings may be automatically analyzed by the analysis system 150 within the security server 115. For example, the analysis system 150 may be configured to compare two still photos of the enclosure 105 at different points in time (e.g., before and after operator access.)

Although not shown, the security server 115 may also maintain an enclosure log. The enclosure log may include information specific to each registered enclosure 105. For example, the enclosure log may list all activity related to each enclosure 105 such as tickets related to that enclosure 105. The enclosure log may also indicate when and who has accessed the enclosure 105. For example, the enclosure log may indicate when an enclosure 105 is accessed, by whom it is accessed, and when the enclosures 105 is re-secured (e.g., locked after service has been performed by the operator.) The enclosure log may also maintain a list of down times, number of service calls required, customers it provides service too, etc. The enclosure log may be used by the analysis system 150 to create an analysis of the enclosures 105. For example, the enclosure logs may collectively be used to generate a list of the most serviced enclosures, the enclosures 105 having the highest amount of down-time, and the like. Similar analysis may be generated using table 500. For example, tickets associated with a certain operator may be analyzed to determine the operator's efficiency and resolution rate when responding to a collective set of tickets. Moreover, managers may also be critiqued based on the response and service associated with their regions. In one example, the time stamps of two recordings may be compared to determine how long an enclosure was accessed by an operator responding to a specific ticket. The average length of time it take an operator to address a specific type of ticket may be used for future scheduling, performance reviews, etc.

Additionally, each type of service problem may be analyzed in view of each operator. For example, one operator may be more efficient in addressing service outages whereas another operator may be well versed in general maintenance of the enclosures. This information may be used to assign tickets to certain operators to increase efficiency in resolving problems.

FIG. 6 shows an exemplary process 600 for responding to an unauthorized access and service outage at a first enclosure 105. In block 605, the security server 115 may receive notification that an enclosure 105 has been accessed without authorization. For example, a person may have broken the access panel 145 and gained access to the enclosure 105 via physical force. Access via the access panel 145 could have also been granted erroneously. For example, an operator's access device 140 could have been stolen and therefore used by an unauthorized person. The security server 115 may learn of the unauthorized access when viewing the photos and/or video uploaded from the cameras. The security server 115 may also receive notification that a service outage associated with that enclosure 105 has occurred. Upon learning of an unauthorized access or service outage, the process proceeds to block 610.

At block 610, the security server 115 determines if there is a second enclosure 105 in communication with, associated with, or otherwise capable of handling some of the services that are typically handled by the first enclosure 105. For example, two enclosures 105 may be capable of supplying services to the same customer premises 110. Moreover, two enclosures 105 may be connected to each other via a feeder cable, and therefore capable of communicating services between each other. In this case, the second, undamaged and un-accessed enclosure 105 may be able to handle at least a portion of the responsibilities usually handled by the first enclosure 105. This determination may be made by reviewing the circuit database within the security server 115. As explained above, the circuit database may indicate which enclosures 105 are in communication with each other, as well as their location, and customer premises 110 that they service. If there is a related enclosure, the process proceeds to block 615, if not, the process ends.

At block 615, the security server 115 may determine whether an auto-repair system may be initiated. An auto-repair system may include automatically calculating how and which services should and can be re-routed to a different cross-connect within an enclosure 105. For example, the auto-repair system may first check for a single outage that affects the most customer premises 110. By finding the outage that is most detrimental to the most subscribers, this outage may be re-routed first. The auto-repair system may then find the next outage affecting the second most customer premises 110, and so on. Additionally, the auto-repair system may determine which, if any, of the outages are affecting premium services. If the outage is too severe, (e.g., affecting a large amount of services over and a large amount of customer premises 110,) the auto-repair system may not be able to handle the outage. Additionally, in the instance where no outages have actually occurred yet, and only unauthorized access has been detected, the circuits may still be addressed by the auto-repair system in an effort to proactively prevent the customer premises 110 from experiencing any outages. If the auto-repair system can handle the outages or predicted outages, the process proceeds to block 620. If the auto-repair system cannot address the outage, the process proceeds to block 625.

At block 620, the auto-repair system may be initiated. The security server 115 may instruct the first enclosure 105 to enter into a ready state mode. Once in the ready state mode, the auto-repair system may perform calculated re-routings of certain services based on the instructions supplied by the auto-repair system. Once the re-routings have occurred, the circuit database may then be updated to reflect such re-routings. By initiating the auto-repair system, the customer premises 110 may, if at all, only suffer from an outage for a small amount of time. The process then ends.

At block 625, in response to the auto-repair system not being able to handle the complexity of the outages, the security server 115 may generate tickets in order to address certain outages. As described above, the tickets may be generated automatically or be initiated by a subscriber. The tickets may include a priority, or urgency, to help inform the operators which tickets to address first. Once the tickets have been generated, the process ends.

Computing devices such those described herein, may employ any of a number of computer operating systems known to those skilled in the art, including, but by no means limited to, known versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, notebook, laptop, or handheld computer, or some other computing device known to those skilled in the art.

Computing devices such as the foregoing generally each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other tangible medium from which a computer can read.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “an,” “the,” “said,” etc. should be read to recite one or more of the indicated elements unless a claim recites an explicit limitation to the contrary.

What is claimed is:

1. A system comprising:
a server configured to:
receive a request to access an enclosure, the request including at least one enclosure identification and at least one operator identification;
identify at least one ticket associated with the enclosure identification;
determine whether the at least one ticket is associated with the at least one operator identification; and
transmit instructions to the enclosure in response to determining whether the at least one ticket is associated with the at least one operator identification.

2. The system of claim 1, wherein the instructions include instructions for granting access to the enclosure in response to the at least one ticket being associated with the at least one operator identification.

3. The system of claim 1, further comprising an access device including the at least one operator identification and configured to initiate the request to access the enclosure.

4. The system of claim 1, wherein identifying the at least one ticket includes searching a plurality of tickets at the server for at least one ticket associated with the enclosure identification.

5. The system of claim 1, wherein the instructions include instructions for denying access to said enclosure in response to the at least one ticket not being associated with the at least one operator identification.

6. The system of claim 5, wherein the server is further configured to:
determine whether the enclosure is located in a high risk area;
determine whether the operator identification is associated with a flagged operator; and
transmit further instructions to the enclosure including instructions to take supplemental security action in response to at least one of the enclosure being located in a high risk area and the operator identification being associated with a flagged operator.

7. The system of claim 6, wherein the enclosure is a first enclosure and the server is further configured to:
determine whether a second enclosure is related to the first enclosure; and
transmit further instructions to the second enclosure including instructions to take supplemental security action in response to the second enclosure being related to the first enclosure.

8. The system of claim 7, wherein determining whether the second enclosure is related to the first enclosure is based at least in part on the location of the first and second enclosures.

9. A method comprising:
receiving, at a server, a request to access an enclosure, the request including at least one enclosure identification and at least one operator identification;
identifying at least one problem ticket associated with the enclosure identification;
determining whether the at least one problem ticket is associated with the at least one operator identification; and
transmitting instructions to the enclosure in response to determining whether the at least one problem ticket is associate with the at least one operator identification.

10. The method of claim 9, further comprising granting access to the enclosure in response to the at least one problem ticket being associated with the at least one operator identification.

11. The method of claim 9, further comprising:
associating an access device with the at least one operator identification; and
initiating the request to access the enclosure via the access device.

12. The method of claim 9, further comprising searching a plurality of tickets at the server for at least one ticket associated with the enclosure identification to identify the at least one problem ticket.

13. The method of claim 9, further comprising denying access to said enclosure in response to the at least one problem ticket not being associated with the at least one operator identification.

14. The method of claim 13, further comprising:
determining whether the enclosure is located in a high risk area;
determining whether the operator identification is associated with a flagged operator; and
transmitting further instructions to the enclosure including instructions to take supplemental security action in response to at least one of the enclosure being located in a high risk area and the operator identification being associated with a flagged operator.

15. The method of claim 14, wherein the enclosure is a first enclosure and further comprising:
determining whether a second enclosure is related to the first enclosure; and
transmitting further instructions to the second enclosure including instructions to take supplemental security action in response to the second enclosure being related to the first enclosure.

16. The method of claim 15, wherein determining whether the second enclosure is related to the first enclosure is based at least in part on the location of the first and second enclosures.

17. An enclosure defining an interior for housing electrical components comprising:
at least one enclosure door defining an inside and outside of the enclosure;
at least one access panel disposed on the outside of the enclosure to receive a request to access the enclosure, the request including at least one operator identification;
at least one camera configured to record at least one image;
a network interface configured to:
transmit at least one of the request to access the enclosure and the at least one image, and
receive a response based at least in part on the at least one of the request to access the enclosure and the at least one image.

18. The enclosure of claim 17, wherein the network interface is configured to:
transmit the at least one of the request to access the enclosure and the at least one image to a security server located remotely from the enclosure, and
receive the response from the security server.

19. The enclosure of claim 18, wherein the response from the security server includes instructions for at least one of granting access to the enclosure and taking a supplemental security action.

20. The enclosure of claim 17, wherein the at least one image includes a photograph of an operator associated with the operator identification.
